(19) United States
(12) Patent Application Publication
(10) Pub. No.: US 2025/0322392 A1
(43) Pub. Date: Oct. 16, 2025

(54) DECENTRALIZED CUSTODIAL WALLETS FOR SECURE BLOCKCHAIN TRANSACTIONS

(71) Applicant: Simba Chain, Inc., Plymouth, IN (US)

(72) Inventors: Kieran Evans, Swansea (GB); George Simpkin, London (GB); Chris Simpkin, Cardiff (GB); Iain Barclay, Chepstow (GB); Matthew Welz, Durango, CO (US); Kareem Williams, Brooklyn, NY (US); Brendan Birch, Denver, CO (US); John Kiernan, New Vernon, NJ (US); Ian Taylor, Clifton, VA (US); Matthew Shroyer, Minneapolis, MN (US); Andrew Harrison, Rhondda (GB)

(21) Appl. No.: 19/175,749

(22) Filed: Apr. 10, 2025

Related U.S. Application Data
(60) Provisional application No. 63/632,433, filed on Apr. 10, 2024.
(60) Provisional application No. 63/725,901, filed on Nov. 27, 2024.

(51) Int. Cl. G06Q 20/38; G06Q 20/36

(52) U.S. Cl. CPC G06Q 20/389; G06Q 20/3678; G06Q 20/3821; G06Q 20/3829

(57) ABSTRACT

Devices and systems for implementing decentralized custodial wallets are described. The described embodiments advantageously provide private key management, decentralization, and privacy. Embodiments of the disclosed technology further provide an example method that includes receiving, from a user, an input indicative of an instruction that creates a decentralized identifier (DID) associated with a public/private key pair of the user that includes a user public key and a user private key. The method further includes transmitting, to a data registry on a blockchain, public information associated with the user and the user public key, generating (a) a verifiable credential (VC) data structure comprising the DID, a plurality of attributes, and a first plurality of proofs, and (b) a verifiable presentation (VP) data structure comprising the VC data structure and a second proof. Herein, each proof of the first plurality of proofs verifies a veracity of a corresponding attribute of the plurality of attributes, each proof is signed by the DID, and the VC data structure is signed by a VC-generation key.

### CROSS-REFERENCE TO RELATED APPLICATIONS

This application claims the benefit of U.S. Provisional Application No. 63/632,433, entitled “Decentralized Custodial Wallets for Secure Blockchain Transactions,” filed Apr. 10, 2024, which application is hereby incorporated by reference in its entirety. This application also claims the benefit of U.S. Provisional Application No. 63/725,901, entitled, “Blockchain-Based Tokenization for Data Verification and Certification,” filed Nov. 27, 2024, which application is hereby incorporated by reference in its entirety.

### TECHNICAL FIELD

This document generally relates to blockchain and distributed ledger technologies, and more particularly, to data tokenization and custodial wallets used in blockchain ecosystems.

### BACKGROUND

A cryptocurrency wallet is a device, physical medium, program or an online service which stores the public and/or private keys for cryptocurrency transactions. Utilizing asymmetric cryptography, these public and private key pairs can be used to track ownership, receipt or spend of cryptocurrencies. In an example, a public key allows others to make payments to the address derived from it, whereas a private key enables the spending of cryptocurrency from that address.

Tokenization refers to the process of creating a token on a blockchain that represents an asset. These tokens can be representations of traditional tangible assets (such as real estate, agricultural or mining commodities, analog artworks, etc.), financial assets (equities, bonds), or nontangible assets such as digital art and other intellectual property. Tokenization gives asset holders and market makers access to blockchain technology's potential benefits. In addition, tokenization offers programmability—that is, the ability to embed code in the token, and the ability of the token to engage with smart contracts—enabling higher degrees of automation.

### BRIEF DESCRIPTION OF THE DRAWINGS

FIGS. 1A-1F illustrate example operations for data verification and certification, in accordance with embodiments of the disclosed technology.

FIG. 2 illustrates a flowchart for an example method for data verification and certification, in accordance with embodiments of the disclosed technology.

FIG. 3 shows an example workflow for data verification and certification, in accordance with embodiments of the disclosed technology.

FIGS. 4A and 4B show example data structures for a verifiable credential (VC) and a verifiable presentation (VP), respectively.

FIG. 5 is a diagram that provides an overview of the different components of a decentralized custodial wallet, in accordance with embodiments of the disclosed technology.

FIG. 6 is a diagram that provides an overview of creating and using a decentralized custodial wallet, in accordance with embodiments of the disclosed technology.

FIG. 7 shows an example flow diagram for creating and configuring a decentralized custodial wallet, in accordance with embodiments of the disclosed technology.

FIG. 8 shows an example flow diagram for configuring a decentralized custodial wallet for different applications, in accordance with embodiments of the disclosed technology.

FIG. 9 illustrates a flowchart for an example method for creating and using a decentralized custodial wallet, in accordance with embodiments of the disclosed technology.

FIG. 10 shows a block diagram of an example processing system in which at least some operations described herein can be implemented.

### DETAILED DESCRIPTION

Blockchain-based tokenization is often discussed in the context of digitally representing and cryptographically securing a variety of asset types to facilitate the transfer of value. Tokenization, however, can also be used to enable privileged and private access to data and resources. Using tokenization to facilitate access to data and resources provides benefits as compared to traditional storage and storage retrieval techniques including the: i.) enablement of publicly auditable and/or verifiable information, ii.) execution of codified business processes and procedures, iii.) encapsulation of multilateral business rules and functions; and iv.) the capacity for authenticated 3rd party data verification, without publicly revealing the underlying information. Furthermore, tokenization on a public, distributed blockchain ledger allows participating parties to take advantage of existing infrastructures and open-sourced development resources to facilitate immutability, transparency, efficiency, decentralization, and scalability.

As compared to existing systems that establish new blockchain networks (e.g., a system of interconnected entities that enables communication and exchange), in some aspects the described embodiments provide a platform (e.g., a system that provides specific services or capabilities that can be accessed and used by other entities) that leverages existing blockchain networks and ecosystems to create private (or arbitrary) data sharing channels—on an ad hoc basis—that enable data privacy, credentialed verification, and public audit of obfuscated private data.

Existing implementations of systems that enable controlled data access are typically based on NFT token gating techniques. “Token gating” a dataset works by requiring data accessors to prove ownership of an NFT in order to obtain access to off-chain data storage through a verification system. Once that ownership is validated, a user or organization can access the gated dataset. The verification system can be integrated with the wallet used to hold the NFT, ensuring a secure and streamlined process.

More specifically, a typical token gating implementation works by using a smart contract on the blockchain to verify ownership of the access-granting NFT. The smart contract can be programmed to require specific tokens to access gated content. When a token holder tries to access the gated content, the smart contract will check if they own the required token. To prove ownership of the token, token holders must sign a message using the wallet holding their NFTs and thereby prove their ownership thanks to the private key associated with it. This message can then be verified by the smart contract to confirm ownership. If this process is successful, the user can access the content. If not, access will be denied.

Unlike token gating, using the teachings herein, users do not need to manage tokens in a blockchain wallet; instead, tokens are decentralized signed documents that rely on a hierarchical chain of trust to operate. That is, rather than using the presence of an NFT for data access control (which requires a blockchain), the present solution uses a digitally signed document for access control. Documents are more flexible and decentralized and can be circulated via email while maintaining the same level of security. Moreover, using digitally signed documents obviates the need for a crypto wallet.

Although this system uses blockchain for the non-repudiable base, it does not require users to know how to create a wallet or know web3 in general, unlike NFT token gating.

Some of the main issues with the security and transition of blockchain assets surround the use of a public/private key pair as the wallet, and therefore, the entry point for securing assets and transferring them. The management of the private keys is riddled with security vulnerabilities because keys can be compromised with a hacker or other nefarious actor gaining access to them, making that wallet's assets open to theft. A user can also lose his/her private key and lose access to those assets forever. Another concerning aspect with this approach is that transactions involving securing and moving assets are visible on public blockchains such as bitcoin and can be tracked back to a wallet because each transaction is signed by the private key of that wallet. For public blockchains which accommodate USDC transactions, for example (and there are many), this would mean that any transaction involving USDC by any users of that system who used their private key to receive and spend the USDC) are visible to every node on the blockchain. Without more safeguards in place, that level of visibility surrounding personal spending present challenges when it comes to the traction needed to fully adopt a cryptocurrency means of commerce.

Embodiments of the disclosed technology provide solutions to these issues in the form of a decentralized custodial wallet which, rather than using asymmetric cryptography directly, wraps the asymmetric keys into a Decentralized Identity (DID), for example, by associating the asymmetric keys with the DID. And, through the use of Verifiable Credentials (VC), an administrator can create a digitally signed VC using its private key, which enables a DID owner to access a smart wallet using the issued verifiable credential, proving they own the wallet, which is placed into a Verifiable Presentation (VP). This then acts as an envelope for delivery to the verifier. A smart wallet is an on-chain smart contract that is able to interact with a token contract, e.g., ERC 20 or ERC 721 and is known as account abstraction. This special account abstraction smart contract can transfer fungible, non-fungible tokens, or other tokens as long as the wallet owner is verified. Access to the wallet can only be made by the DID presenting the VP, which incorporates the VC. The VC is the key part that is digitally signed proof that provides Bob access to the data. However, Bob needs to prove that he in fact who he says he is (i.e., the owner of the DID). To do so, Bob must validate by encrypting a challenge to prove that he owns the private key associated with the DID.

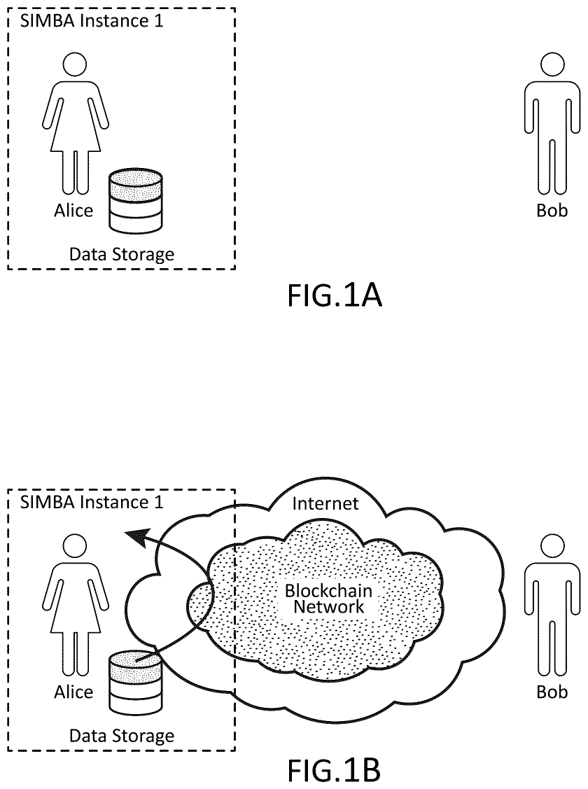

In some aspects of the described embodiments, a blockchain-based tokenization system for data verification and certifications is provided and includes a platform that comprises a mechanism for arbitrary data input and output, a mechanism for data recipient permissioning, and a mechanism for internet facing data storage. Each of the aspects is further illustrated in the context of FIGS. 1A-1F, which show example operations for data verification and certification, in accordance with embodiments of the disclosed technology.

As introduced in FIG. 1A, assume Alice determines she wants to share an arbitrary dataset with Bob. For purposes of this scenario the data set could be _an excel file_, but it is contemplated that the dataset is any type of data that Alice might chose to share with Bob. As depicted in FIG. 1B, Alice places that arbitrary data into data storage, which can be any appropriate storage that the data owner has access to and that the data owner can issue tokens for giving others access to. The data owner then mints a digital asset token (e.g., a non-fungible token or NFT) on an arbitrary blockchain network that permits access to that arbitrary dataset by using a Verifier smart contract which validates the DID and the digital signatures and creates a token, giving the DID access to the data storage and therefore dataset.

In some embodiments, creating the token includes (1) asset sourcing, (2) token issuance, and (3) token distribution. Asset sourcing typically begins with identifying the asset and the structure to be tokenized. Additionally, it helps to understand whether the asset will be treated as a security or commodity, and which regulatory frameworks will apply. Token issuance is a process well-understood to those skilled in the art and includes creating a digital representation of the asset on a blockchain in the form of a token with embedded functionality—that is, code for executing predetermined rules. This is implemented by selecting a particular token standard (e.g., ERC 741 or ERC 1155), a network (private or public blockchain), and (compliance) functions to be embedded. Once the token has been issued, it can be distributed to the owner or provider of the asset (e.g., Alice).

Alice communicates the token to Bob (FIG. 1C). The token is the public address of the NFT, so Alice can send it to Bob by whatever means she can. The token never gives access, it merely shows Bob where to present the VP/VC to. Using the token and a standard internet connection, Bob is able to access the arbitrary dataset (FIG. 1D). In FIG. 1E, Bob elects to make Vanna aware of the data Alice shared with him, but not show the data itself. Bob could determine what ‘metadata’ he wanted to include, put it in his own instance of data storage, and mint a subsequent token (linked to Alice's initial token) that controls access to that metadata. So, in this scenario Alice has created access control to the data, while Bob has created access control to the metadata of the data. So, a user would first have to get the metadata from Bob using one (Bob issued) VC and then get access to the data using another (Alice issued) VC. They are linked by including the public address of Alice's token in Bob's metadata.

In this way, Bob can release a digitally signed summary attesting to the quality, rigor, existence, veracity or validity of the data without needing to share the data directly. Finally, in FIG. 1F, Vanna can use the subsequent token to (publicly) verify that Bob ‘endorsed’ Alice's data but is not able to see the data itself.

In the context of FIGS. 1A-1F, “access control” determines who has access to what, e.g., Bob can access the data owned by Alice, and Vanna can access metadata, generated and owned by Bob, which corresponds to the data. The arbitrary dataset is characterized in terms of “verifiability” (e.g., Bob can verify Alice's data because he has inspected the data himself), “custody” (e.g., Alice, who owns the arbitrary dataset, continues to have custody of the arbitrary dataset), and “data sharing rules” that specify how the data can be shared, modified, transferred, etc. The data sharing rules are implemented using attributes and values, which form a data first policy surrounding the data. These attributes are included in the VCs and are embedded as a policy in the NFT. When a Verifier checks the validity of the DID data accessor, the Verifier also checks to the see if the attributes in the VC match the attributes in the NFT. If they do, access is granted. If not, access is denied.

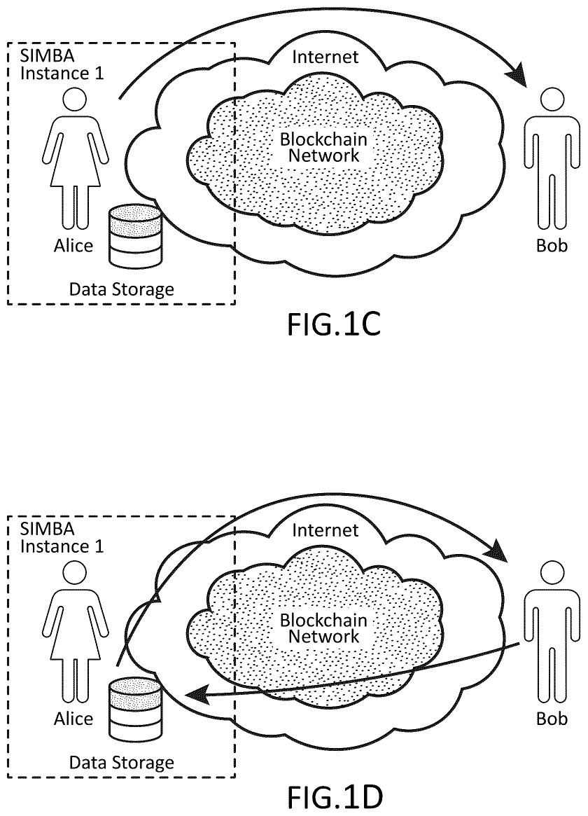

FIG. 2 illustrates a flowchart for an example method 200 for data verification and certification. The method 200 includes, at operation 210, minting a token which includes a decentralized identifier (DID) associated with a dataset, on a blockchain. This can be accomplished by including the data DID (a new DID for this dataset) as part of the metadata of the NFT representing the data. Decentralized identifiers (DIDs) are globally unique identifiers made up of a string of letters and numbers that act like an identifying address on a blockchain and are independent of any organization. DIDs can be used to digitally sign and issue verifiable credentials, verify credentials instantly, and show credentials to verifiers.

In some embodiments, the token further includes an identifier of the blockchain and a plurality of functions. In some embodiments, the DID is verified based on a one-shot verification that uses a zero-knowledge proof. Each token can include multiple ways of performing the verifier role. A verifier could take a VP/VC or it could take a VP/ZKP that contains the proof that the VC exists. Thus, there can be multiple verification mechanisms. In some embodiments, the plurality of functions comprise one or more application programming interface (API) functions for off-chain Verifiers. For example, a bartender might have an API one his/her phone to verifier a patron presenting a VC to verify age.

The method 200 includes, at operation 220, creating a verifiable token by converting the credential (VC) into a token which has the advantage of making the VC searchable. For example, if ten people attest that a data set is high quality then a new user could search using the DID of the data whether it has been attested to be of good quality. By searching on the DID they can find all verifiable tokens that attest that the data is of high quality. In some embodiments, the verifiable credentials are generated using the DID and an asymmetric cryptographic technique. That is, a VC is created by a DID digitally signing a VC that includes the issuing DID.

The method 200 includes, at operation 230, transmitting the verifiable token to a recipient. For example, in this case, Alice sending Bob the VC/token, wherein the token is the NFT representing the dataset, which includes a hash of the off-chain data to confirm it has not been altered or tampered with.

In some embodiments, receipt of the verifiable token enables the recipient (in this case, Bob) to use at least one of the plurality of functions to access the dataset in the web-facing segregated data storage using a web-based platform.

In some embodiments, the token includes a hash value that is generated based on the arbitrary dataset (e.g., either the entire dataset, or some portion of the dataset). Alternatively, or additionally, the token is associated with a decentralized identifier (DID). That is, the NFT that represents the data can also be issued a DID, so that others can issue a credential to the data DID for proving it is valid without see the actual data.

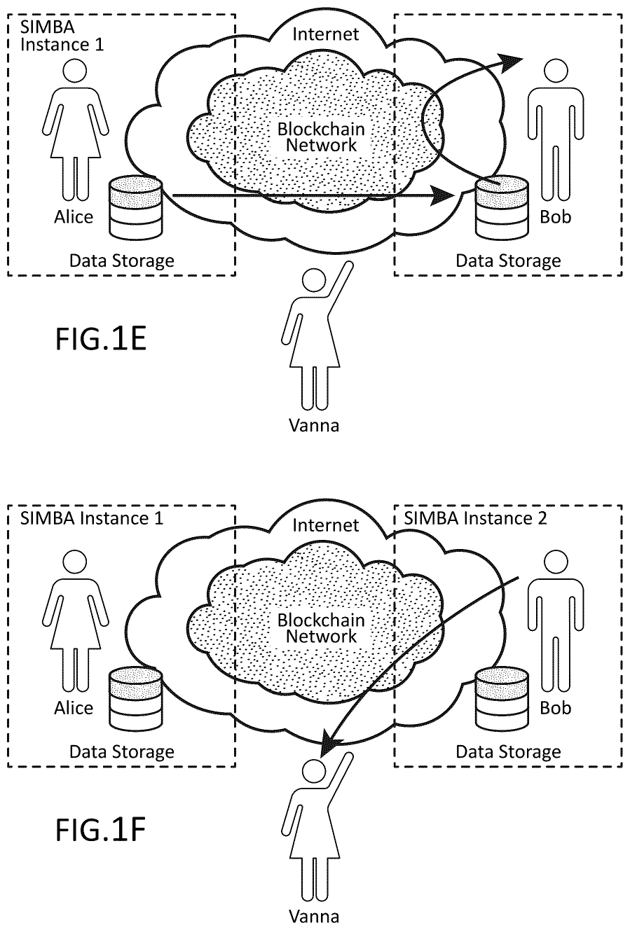

FIG. 3 shows one embodiment of an example workflow for data verification and certification, in accordance with embodiments of the disclosed technology. Specifically, it shows the workflow between a trusted third party (310), Alice (320), a computing system in accordance with the disclosed technology (330, and denoted SIMBA), a blockchain (340), a private storage (350), and Bob (360), with Alice and Bob being previously referenced in FIGS. 1A-1F. The workflow shown in FIG. 3 consists of two distinct transactions (separated by the horizontal dashed line below the “Verifier Process”) that include (1) Alice securely sending a file to Bob, and (2) Bob publicly attesting to Alice's file.

As shown in FIG. 3, step (1) includes steps (1a) and (1b) that correspond to each of Alice (320) and Bob (360) receiving a decentralized identifier (DID) in step 322 and step 362, respectively. In an example, Bob's DID credentializes him as a “VP of Engineering.” Alice's DID is committed to the blockchain (340) in step 342, and in step 344, Bob's DID is committed to the blockchain (340). In step (1), Alice's DID and Bob's DID were created by the trusted third party, which also issues Bob a credential, using his DID, stating that he is a VP of Engineering.

In step (2), Alice (320) wants to share a file with Bob (360). In step (2a), Alice (320) uploads a file to SIMBA (330), in step 332, and implements a policy where only a “VP of Engineering” may access her file. In step (2b), Alice's file is uploaded by SIMBA (330) to the blockchain (340), and triggers, in step 346, the generation of (i) an NFT that uniquely identifies Alice's file (because the NFT contains a hashcode to the content of the data) and (ii) a hash of the file that is stored as a token ID in the NFT, as one example approach. In step (2c), SIMBA (330) stores the file in a private off-chain file storage system (350) in step 352, which is accessible through DID-based credentials. In step (2d), SIMBA (330) provides the token ID of the NFT (that was generated using the uploaded file) to Alice (320).

In step (3), Alice (320) sends the token ID for the NFT to Bob (360).

In step (4), Bob (360) uses his credentials to access Alice's file. Specifically, Bob (460) presents his credential to the system. The verification system verifies the credential and the presentation of the credential, as explained above. It then looks up the token ID and locates the NFT and verifies the policies associated with the resource in the NFT against the claim in the credential. More particularly, Bob (using his DID) presents a VC wrapped in a VP to a smart contract, which contains a Verifier which verifies the VC and returns an Auth token if successful to the data. Verifiers are on-chain smart contracts and hence all verification activity is non-repudiable and the verification steps and results cannot be changed after the fact making it very secure.

In some embodiments, the “Verifier Process” shown in FIG. 3 is implemented using the following operations. The verification system provides Bob with a challenge to add to the proof, as discussed herein. This is a nonce challenge (monotonically increasing number) associated with the requesting DID. The presenter (Bob in this case) takes the challenge, the address of the verifier contract and signs with his private key along with the signed proof of the credential and includes that in the presentation. This is used to prove that the presenter is the subject of the credential that contains the claim that Bob is a VP of engineering and also to prove that this same subject is the identity making the current request for the file.

The verification system calls the public registry contract to get the addresses (public keys) of the DIDs in the credential and presentation. The verification system also calls the public registry contract to confirm that the credential has not been revoked. The verification system then checks against the registry contract to confirm that the DID of the entity that signed the credential is a trusted DID that is allowed to issue credentials for accessing data. The verification system checks to ensure that the challenge is the correct challenge associated with the presenter DID and that the presenter's signature of the challenge and the signed credential proof are valid. The verification system confirms that the credential supplied has not been changed, for example, by hashing the credential and comparing it with the decrypted credential signature to check whether the hashes match. It then does a match on the policy to check that the presenter is allowed access to the resource. In some embodiments, for example, in situations where the claim values need to be private, zero-knowledge proofs (ZKPs) are used instead of the explicit policy evaluation.

Continuing with the description of FIG. 3, the second transaction shown therein is Bob publicly attesting to Alice's file. In step 364, Bob (360) uses his credentials to sign a credential that references the token presented by Alice (320). The blockchain (340), in step 348, generates a token or adds a credential to the token that was passed to Bob (360) by Alice (320). The result is publicly available but does not expose information about Alice (320) or her file.

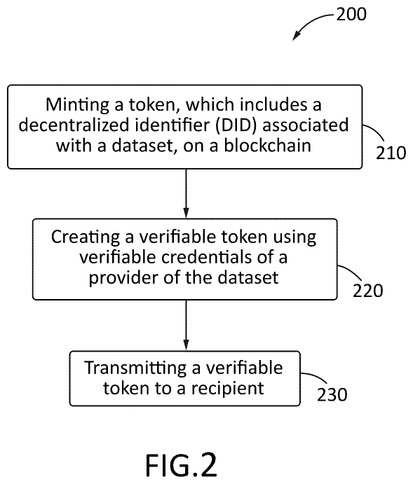

In some embodiments, an administrator can configure a decentralized custodial wallet for a user, e.g., Bob, to use for verification and authentication. In this example, an administrator, much like a Certificate Authority (CA) for SSL, administrates accounts on behalf of individuals, and can provide access to a smart wallet by issuing a verifiable credential (VC) to Bob by incorporating the DID for Bob into a digitally signed VC, and giving that VC to Bob. A representative data structure 400 for a VC is depicted in FIG. 4A and includes credential metadata 410, one or more claims(s) 420, and one or more proof(s) 430.

The administrator further provisions a smart wallet for Bob for use with a policy that can accept this VC as authentication. A verifiable credential system is made up of an issuer (e.g., training organization), a holder (e.g., job applicant), and a verifier (e.g., employer). Herein, the issuer is an organization or party with the authority to issue verifiable credentials that confirm a claim, and the issuer has its own unique DID. A holder is an organization or individual who owns the credential and has his/her/its own DID. A verifier is the person or organization verifying the ownership and trustworthiness of the credential.

Whenever Bob wants to use the wallet, Bob uses a verifiable presentation (VP) and presents this to the on-chain verifier, such as the verifier discussed above with reference to FIG. 4. A representative data structure 440 for a VP is depicted in FIG. 4B and includes presentation metadata 450, one or more verifiable credential(s) 460 and one or more proof(s) 470. For example, Bob can make a call to a nonce method on the smart contract and retrieve a current nonce associated with Bob's DID. In some examples, the nonce (or challenge) is a monotonically increasing random or pseudorandom number, which is stored in the smart contract. The nonce retrieved by Bob corresponds to Bob's DID for the current time, i.e., until it is verified. Stated differently, the nonce is equivalent to a one-time keypad that renders the disclosed embodiments invulnerable to replay attacks. Once the nonce has been verified (e.g., by the on-chain smart verifier contract), the nonce is incremented, i.e., if Bob were to subsequently retrieve a nonce, it would necessarily be different from the one received the first time. In some embodiments, the smart contract is configured to be called by multiple users/DIDs and will issue a nonce for each request. The nonce (or challenge) is generated by using a mapping between the nonce and the user's DID (or other uniquely identifiable information about the user). Bob can then encrypt the nonce using his private key which he then includes in a verifiable presentation (VP). As such, a verifiable presentation is created that includes this challenge (the nonce signed using Bob's private key) along with the VC that provides access to the smart wallet. Once the on-chain verifier receives this information, it then verifies the VC contains the correct DID in the subject field verifies the VC has not been revoked via the on-chain Credential Registry smart contract, and verifies the DIDs public key is indeed associated with the identity defined in the DID via the on-chain Credential Registry smart contract, all as discussed above with reference to FIG. 3. Using this DID's public key, the on-chain verifier may then decrypt the nonce and check to see if it contains the nonce currently associated with the DID. If it does, then ownership of the DID is proven. As discussed above, once the nonce is verified, the nonce is incremented by the smart contract upon receiving verification of the nonce, i.e., that particular nonce is never reused by that user/DID. In some examples, the verifier smart contract issues the nonce, verifies the signed nonce, and increments the nonce. In other examples, a first verifier smart contract issues the nonce, a second verifier smart contract verifies the signed nonce, and the first verifier smart contract then increments the nonce.

A verification may then be made to ensure the VC digital signature is a trusted administrator for this wallet. That is, the digital signature is checked by looking up the public key of the DID of the data administrator for this NFT in an on-chain DID registry to make sure they are a trusted member of the domain. Access to the wallet is granted if these verifications/checks pass. Since the VC does not reference the subject of the claims using the public/private keys of the DID, a VC persists even though the public/private keys may change. Thus, an administrator can rekey the DIDs keys without affecting the user's ability to access their wallet. In some embodiments an on-chain repository (e.g., the on-chain Credential Registry smart contract) contains the public keys of administrators and of DIDs registered so that checks can be made as to the authenticity of those DIDs associated with those keys.

Thus, the described embodiments enable the design and implementation of on-chain noncustodial wallets using existing authenticators to digital networks and provide a simple way to use blockchain networks to host digital currencies.

### 2 Examples Components of Decentralized Custodial Wallets

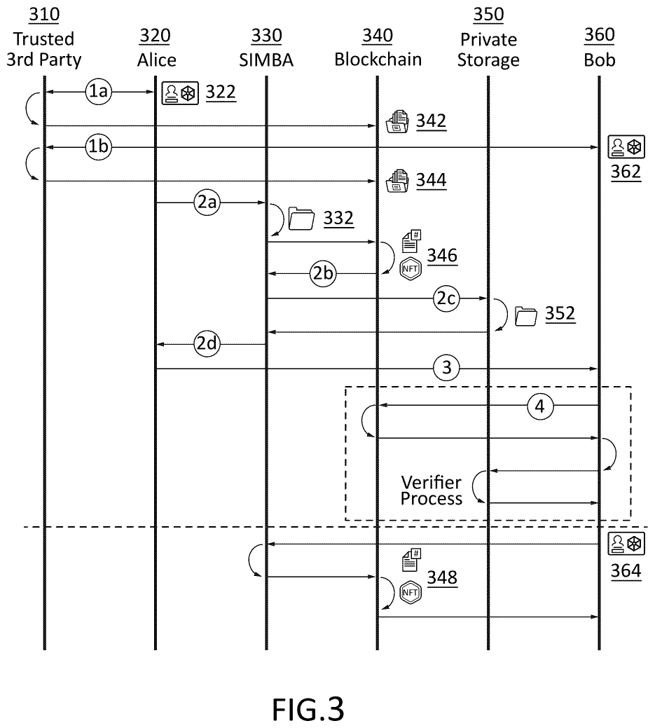

FIG. 5 is a diagram that provides an overview of the different components of a decentralized custodial system 500, in accordance with embodiments of the disclosed technology. In some embodiments, the decentralized custodial system includes various features:
A Decentralized Identifier (DID) 502 which provides a unique identifier that can be used to verify an identity. DIDs are resolvable, similar to web addresses i.e. a URL, and have an associated public/private key pair. A DID can be issued and verified;
A Verifiable Credential (VC) 504, such as discussed above with reference to FIG. 4A, which provides information about their subject, such as qualifications, skills, or other attributes. A VC is a digitally signed document (encrypted by the DID's private key) that may contain the DID of the VC subject, an optional claim payload(s) (used to communicate a qualification, attestation, certification, etc. for that recipient) and a proof that contains a digital signature of the VC itself, along with other information used to verify the proof (e.g., a nonce). A VC can be issued and verified;
A Verifiable Presentation (VP) 506, such as discussed above with reference to FIG. 4B, which packages the data required perform verification. A Verifiable Presentation (VP) wraps a VC, providing both the VC proof and a further VP proof, proving that the presenter is the subject referenced in the VC and that the presenter is presenting that VP. The VP may contain auxiliary metadata, the VC, proof that the VC has been signed by the subject of the VC, and validates that the DID and VC are still valid;
A Verifier Contract (VC) 508 takes the Verifiable Credential (VC) and VP proof information and validates that DIDs against the DID Registry; and
A DID Registry stores public information about DID and the public keys associated with them.

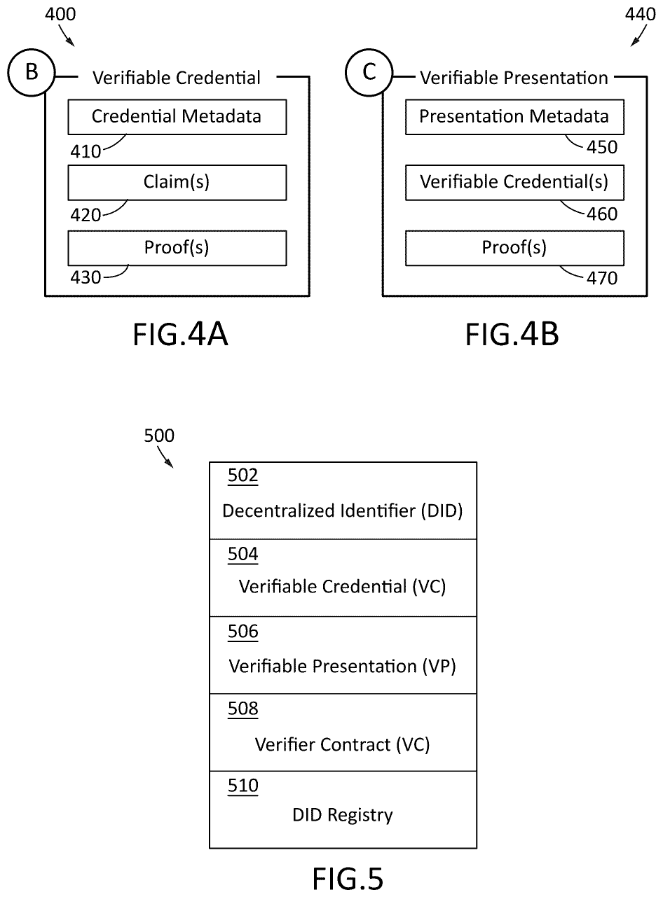

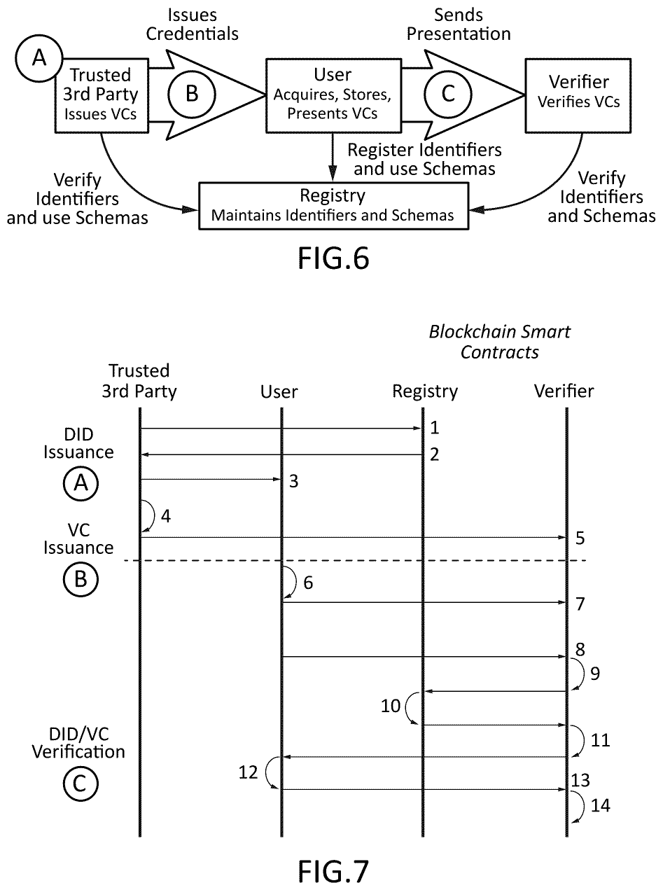

With an appreciation of the above, FIG. 6 is a diagrammatic review for creating and using a decentralized custodial wallet in accordance with one or more embodiments. As shown in FIG. 6, Steps A, B, and C correspond to the issuance of the DID, the issuance of the VC, and the verification of the DID and VC, respectively. The steps are further explained in the context of FIG. 7, which shows an example flow diagram for creating and configuring a decentralized custodial wallet, in accordance with embodiments of the disclosed technology. The flow diagram in FIG. 7 describes the interactions between the user, a trusted third party (e.g., an administrator), the on-chain registry (e.g., an on-chain Credential Registry smart contract or the DID Registry), and the on-chain verifier (e.g., the Verifier Contract).

As shown in FIG. 7, Step A includes a trusted 3rd party electing to issue a DID to a new user (step 1). In some cases, the trusted 3rd party may generate the key pair, whereas in other instances, the new user is responsible for key pair generation. The user and the public key are added to a blockchain-based Registry Smart Contract (step 2), and the user is provided with their new DID (step 3).

Step B includes an existing DID (in this instance the trusted 3rd party) electing to create a new VC for a given subject (step 4). A digitally signed document (a VC) is generated and is signed by the trusted 3rd party's private key. That VC also contains the DID of the VC subject (Bob, in this case) along with one or more claims. A Verifier Contract is invoked (step 5). Alternatively, an existing DID elects to create a new VC. The digitally signed document (a VC) is generated and is signed by the DID's private key (step 6). That VC contains the DID of the VC subject along with one or more claims, and then, a Verifier Contract is invoked (step 7).

Step C involves a multi-step process for verification of Bob's DID/VC combination (steps 8-10). Initially, Bob presents the VC/VP to a Verifier Contract (step 8), which performs VC Issuer (DID) verification (step 9). This is accomplished by looking in a registry to verify authenticity of the issuer's (Alice's) digital signature (step 10). This ensures the VC was issued by a trusted entity using public key Registry Contract lookup to verify that the VC proof was signed by the VC issuer DID. Steps 11-13 relate to the challenge. The verifier then sends the challenge to the user (Bob) (step 11). Bob then encrypts the challenge to prove that the VP was signed by the VC subject (Bob) (step 12). If verification succeeds, then the DID/VC combination is valid (step 13). The VP proof may contain a nonce or challenge which is used to combat signature replay attacks. Finally, the Verifier creates an audit transaction (step 14).

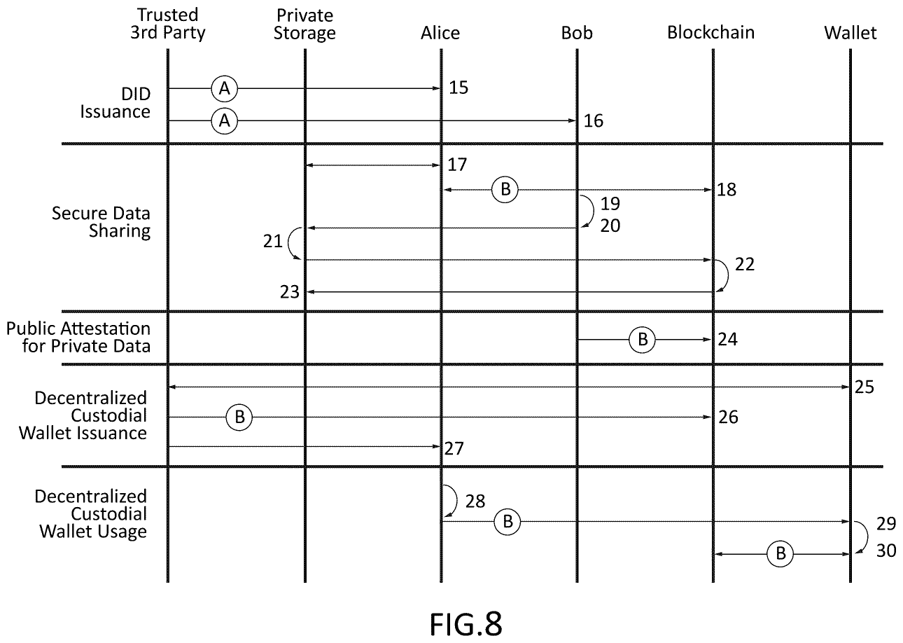

FIG. 8 shows an example flow diagram for configuring a decentralized custodial wallet for different applications, such as data sharing. Each of the different applications begins with the DID issuance shown in FIG. 8, where the trusted 3rd party provisions a first DID for Alice (step 15) and a second DID for Bob (step 16).

In some examples, the disclosed technology provides secure data sharing, as introduced in FIGS. 1A-1F and 4 above. In this regard FIG. 8 illustrates another example embodiment of data verification and certification that expands upon the teachings introduced in FIGS. 1A-1F and 3, above, by incorporating the DID, VC and VP concepts discussed herein. These examples include Alice putting arbitrary data in her (secure, web-facing) Private Storage Service (step 17), and generating a VC that grants Bob access to that arbitrary data using a VC Claim. Alice then issues the VC to Bob (step 18). Bob wraps the VC in a VP signed with his DID's private key (step 19). Bob presents the VP to the Private Storage Service (step 20). The Private Storage Service validates the data access claim (step 21) by invoking the Verifier smart contract with Bob's VP that wraps the VC signed by Alice's DID's private key (step 22). If the DID/VC verification tests pass, then the Private Storage Service provides Bob with access to Alice's arbitrary data (step 23).

In some examples, the disclosed technology provides public attestation for private data, as also shown in FIG. 8. These examples include Bob creating a new publicly visible VC that makes a claim of authenticity of Alice's private data via a one-way hash which keeps Alice's data private while cryptographically referencing the data (step 24). In this example, and unlike other scenarios where the VC is wrapped within the VP, the VC is publicly visible because the private data is being publicly attested to by a third-party verifier that does not own the private data. Here, the publicly visible VC is likely used only to attest to the private data (because its use in any other context may be compromised by it being publicly visible).

In one example, certifications for competencies (or credentials) are publicly visible VCs, e.g., a nurse or doctor moving across state lines could use the disclosed embodiments to prove that they are properly credentialed to work in the new state. In another example, certifications for environmental, social & governance (ESG) claims and carbon credit related claims can be performed using the described embodiments in a streamlined manner. In this example, a user could make a claim for performing a specific type of farming on a farm with a certain acreage and store this claim in a private data storage. A third-party verifier would be able to access the private information and publicly support the user's claim for the associated carbon credit, but there would be no need to disclose the identity of the user, where the farm was located, the acreage, etc. That is, all the underlying information could be verified without exposing any of that information.

In some examples, the disclosed technology provides decentralized custodial wallet issuance and usage. A decentralized custodial wallet provides specific wallet access to a particular DID. Usage of the wallet can only be achieved by presenting a VP and proving that the owner of the DID attempting access is the DID associated with the wallet. This is achieved by encrypting a challenge (a monotonically incrementing number mapped to the DID) that is issued by the wallet before access is attempted. Using the DID private key, the challenge is signed as part of the VP proof so that the smart wallet can check the presenter is authentic by decrypting the challenge using the corresponding public key. The public key is verified and retrieved from the DID Registry contract. As shown in FIG. 8, these examples include the trusted 3rd party provisioning a digital wallet or smart contract (step 25), and issuing a signed VC to Alice's DID that permissions Alice to the provisioned wallet (step 26). Alice is given the digital wallet address (step 27), receives a digital asset in her wallet, and decides she wants to transfer it (step 28). To achieve this, Alice presents a signed VP that wraps the wallet VC to the wallet contract (step 29), which uses the verifier contract and DID registry contract to verify Alice's request and then executes the asset transfer on her behalf (step 30).

The disclosed embodiments provide solutions for on-chain contact tracing and data analysis for healthcare applications. In some examples, the solutions include translating real-time public health indicators into future demand signals that predict supply chain needs, thereby enabling participating medical institutions to leverage predictive modeling to accurately assess and respond to future needs, reducing the risk of supply shortages.

In some examples, a local health alert system (LHAS) can incentivize certain activities by rewarding users with points, which are redeemable for cash. However, different LHAS deployments may implement different reward programs with their own reward program tiers. Embodiments of the disclosed technology provide a multi-level reward program using NFTs with fungible tokens providing the points to move between reward program tiers in different LHAS installations. A user is empowered to maximize and consolidate their rewards across their e-commerce, travels and general day-to-day business interactions.

In other words, users will have full control over their rewards, and can port them between different LHAS deployments, or other rewards initiatives. For example, an existing user could continue to earn points for participating in a pilot and may attend an external conference event during the trial, which is also using LHAS to e-check participants into the venue. In return, users are issued points, which are added directly into their wallet and can be brought back into the LHAS system. As discussed earlier, this approach has several benefits.
1. The user has control of a DID wallet that accesses a blockchain wallet, and therefore, does not have to manage the blockchain wallet directly.
2. The decoupling of the DID wallet and the blockchain wallet means that a user can never lose their private key for their blockchain wallet, solving a significant problem in the blockchain space (people lose access to their private keys often, thereby losing the contents of that wallet). Using this decoupled approach, it is impossible to lose your blockchain private key and your assets.
3. The DID wallet also has a public/private key, but by implementing the W3C specification, keys can be reissued. Therefore, a user can never lose his/her/its DID identity. The reissuing of a DID public/private key does also not affect the VCs that are issued because the VCs are issued for the DID not the keys associated with that DID. So, reissuing the DID keys is a simple operation that gives the user immediate access to their assets.

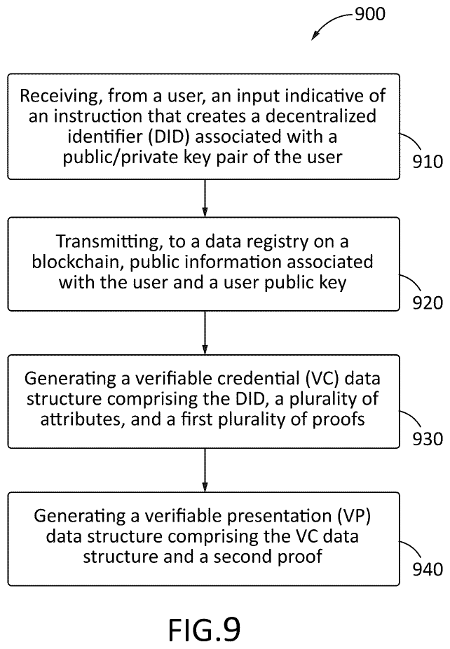

FIG. 9 illustrates a flowchart for an example method 900 for creating and using a decentralized custodial wallet. The method 900 includes, at operation 910, receiving, from a user, an input indicative of an instruction that creates a decentralized identifier (DID) associated with a public/private key pair of the user. In some embodiments, the public/private key pair of the user comprises a user public key and a user private key.

The method 900 includes, at operation 920, transmitting, to a data registry on a blockchain, public information associated with the user and the user public key.

The method 900 includes, at operation 930, generating a verifiable credential (VC) data structure comprising the DID, a plurality of attributes, and a first plurality of proofs. Herein, each proof of the first plurality of proofs verifies a veracity of a corresponding attribute of the plurality of attributes, each proof is signed by the DID, and the VC data structure is signed by a VC-generation key.

The method 900 includes, at operation 940, generating a verifiable presentation (VP) data structure comprising the VC data structure and a second proof.

In some embodiments, the method 900 further includes a data verifier on the blockchain being configured to perform a first verification, based on the public information in the data registry, to verify the VC data structure being issued by a trusted entity, perform a second verification to verify each of the first plurality of proofs being signed by the DID, perform a third verification, based on the public information in the data registry and the second proof comprising a nonce, to verify the VP data structure being signed by a subject of the VC data structure, and create an audit transaction on the blockchain comprising results of the first verification, the second verification, and the third verification.

It should be appreciated that embodiments of the disclosed technology may provide at least one or more of the following advantages:

Private key management: When using a crypto wallet, if a private key is lost, a user loses access to those assets forever. Or if a private key is stolen, the thief can move those assets to their own wallet or transfer them to fiat using an exchange. Using a decentralized custodial wallet approach makes it impossible for a user to lose access to their crypto. Even if a user loses their DID private key, an administrator can simply issue a new one to that DID and register the new public key in the DID repository and expire the old one. The user can then access the smart wallet with the new private key. This also helps to prevent theft because as soon as the wallet owner understands a key might have been compromised, it can request that the administrator rekey them thereby preventing the thief from gaining access without the correct private key. It is noted that, in the described embodiments, the thief would be successful only if the thief had stolen both the private key and the DID of the user. Alternatively, if a m-of-n multi-signature encumbrance were being used, then the thief would have steal a quorum of DIDs associated with the user (instead of just the user's DID).

Decentralization: The controller of the DID can be a single administrator or can be a group of participants that administer the account, and a consensus mechanism can govern its administration. For example, there could be five control agents for the account with a threshold of three signatures being needed to rekey the account (e.g., a 3-of-5 multi-signature encumbrance). In this way, it is possible to decentralize the administration and avoid the system being controlled by any single entity.

Privacy: Using the disclosed embodiments enables transactions to remain completely private. The only transaction that happens surrounds the verifier and that transaction is made by the logger who logs the transaction. However, since this logger represents many users (potentially thousands) there is no digital thread connecting the transaction back to the user making it. Therefore, transactions are completely private, but they can be identified through the administrator, if such an administrator kept an internal log of such transactions. This situation is quite similar to the way banks work right now, with customer transactions being private to each customer but logged using a trusted 3rd party (the bank). This approach could provide the benefits of a digital currency (low fees, non-hackable transactions, etc.) with the privacy that would be required by the community.

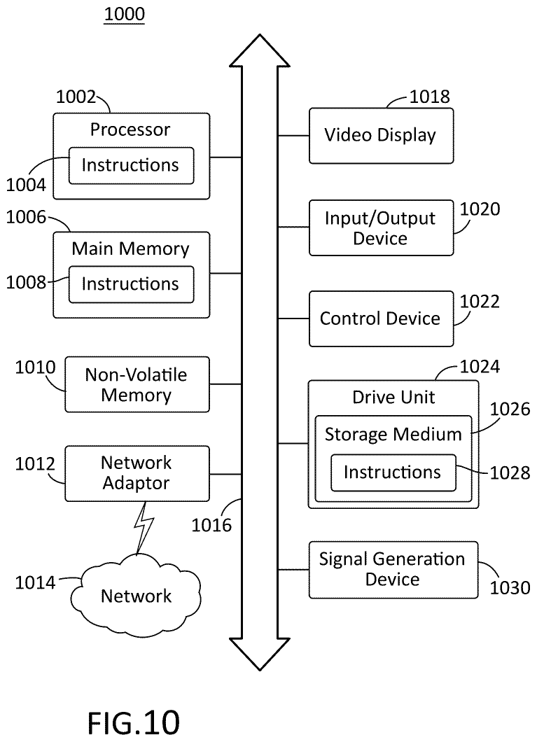

FIG. 10 includes a block diagram illustrating an example of a processing system 1000 in which at least some operations described herein can be implemented. For example, components of the processing system 1000 may be hosted on a computing device through which an individual is able to interact with the blockchain-based tokenization system for data access and/or the web-based platform that accesses the web-facing segregated data storage (e.g., through interfaces presented via a computer program, such as a mobile application, desktop application, or web browser). As another example, components of the processing system 1000 may be hosted on a computing device on which aspects of the described systems and platforms are implemented.

The processing system 1000 may include any combination of a processor 1002, main memory 1006, non-volatile memory 1010, network adapter 1012, video display 1018, input/output devices 1020, control device 1022 (e.g., a keyboard or pointing device), drive unit 1024 including a storage medium 1026, and signal generation device 1030 that are communicatively connected to a bus 1016. The bus 1016 is illustrated as an abstraction that represents one or more physical buses or point-to-point connections that are connected by appropriate bridges, adapters, or controllers. The bus 1016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 1106, non-volatile memory 1010, and storage medium 1026 are shown to be a single medium, the terms “machine-readable medium” and “storage medium” should be taken to include a single medium or multiple media (e.g., a centralized/distributed database and/or associated caches and servers) that store one or more sets of instructions 1028. The terms “machine-readable medium” and “storage medium” shall also be taken to include any medium that is capable of storing, encoding, or carrying a set of instructions for execution by the processing system 1000.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in a computing device. When read and executed by the processor 1002, the instruction(s) cause the processing system 1000 to perform operations to execute elements involving the various aspects of the present disclosure.

Further examples of machine-and computer-readable media include recordable-type media, such as volatile memory and non-volatile memory 1010, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 1012 enables the processing system 1000 to mediate data in a network 1014 with an entity that is external to the processing system 1000 through any communication protocol supported by the processing system 1000 and the external entity. The network adapter 1012 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. A non-transitory computer-readable medium with instructions stored thereon that, when executed by a processor of a computing device, cause the computing device to perform operations comprising:
receiving, from a user, an input indicative of an instruction that creates a decentralized identifier (DID) associated with a public/private key pair of the user, the public/private key pair of the user comprising a user public key and a user private key;
transmitting, to a data registry on a blockchain, public information associated with the user and the user public key;
generating a verifiable credential (VC) data structure comprising the DID, a plurality of attributes, and a first plurality of proofs, wherein each proof of the first plurality of proofs verifies a veracity of a corresponding attribute of the plurality of attributes, wherein each proof is signed by the DID, and wherein the VC data structure is signed by a VC-generation key; and
generating a verifiable presentation (VP) data structure comprising the VC data structure and a second proof,
wherein a data verifier on the blockchain is configured to:
perform a first verification, based on the public information in the data registry, to verify the VC data structure being issued by a trusted entity,
perform a second verification to verify each of the first plurality of proofs being signed by the DID,
perform a third verification, based on the public information in the data registry and the second proof comprising a nonce, to verify the VP data structure being signed by a subject of the VC data structure, and
create an audit transaction on the blockchain comprising results of the first verification, the second verification, and the third verification.

2. The non-transitory computer-readable medium of claim 1, wherein the operations further comprise:
permitting the creation of a new DID comprising a new public/private key pair of the user that includes a new user public key and a new user private key;
transmitting, to the data registry, the public information associated and the new user public key; and
updating the VC data structure with the new DID.

3. The non-transitory computer-readable medium of claim 1, wherein the data verifier is associated with a third-party attempting to verify one or more of the plurality of attributes.

4. The non-transitory computer-readable medium of claim 1, wherein the DID is associated with a crypto wallet owned by the user.

5. The non-transitory computer-readable medium of claim 4, wherein the crypto wallet can be accessed, using the DID, to perform a crypto transaction on the blockchain without exposing the user private key.

6. The non-transitory computer-readable medium of any of claims 1 to 5, wherein the operations further comprise:
creating, based on the input, the user public key and the user private key.

7. The non-transitory computer-readable medium of any of claims 1 to 5, wherein the input comprises the user public key and the user private key.

8. The non-transitory computer-readable medium of any of claims 1 to 7, wherein the VC-generation key is a private key of a trusted third-party.

9. The non-transitory computer-readable medium of any of claims 1 to 7, wherein the VC-generation key is the user private key.

10. The non-transitory computer-readable medium of any of claims 1 to 9, wherein the creation of the DID is based on a consensus mechanism amongst a plurality of control agents.

11. A system for implementing a decentralized custodial wallet that provides anonymous access to a cryptographic wallet on a blockchain, comprising:
a trusted third-party configured to issue a decentralized identifier (DID) to a user, wherein the DID is associated with a first public/private key pair that is different from a second public-private key pair of the user;
an on-chain registry smart contract; and
an on-chain verifier smart contract,
wherein the trusted third-party is further configured to:
create, for the user, a verifiable credential (VC) that is encrypted using a private key of the first public/private key pair, and
create, for the user, a verifiable presentation (VP) that wraps the VC and enables the user to access the cryptographic wallet without revealing information associated with the second public/private key pair, and
wherein the on-chain verifier smart contract is configured to process the VP and allow the user access to the cryptographic wallet.

12. The system of claim 11, wherein the on-chain registry smart contract and/or the on-chain verifier smart contract is controlled by the trusted third-party.

13. The system of claim 11, wherein the on-chain registry smart contract is configured to store the DID and at least some public information associated with the user.

14. The system of claim 11, wherein the on-chain verifier smart contract is configured to generate an audit transaction comprising a result of the user accessing the cryptographic wallet.
